(19) United States
(12) Patent Application Publication
(10) Pub. No.: US 2026/0213530 A1
(43) Pub. Date: Jul. 23, 2026

(54) POWER SUPPLY SYSTEM FOR PORTABLE ELECTRONIC DEVICE

(71) Applicant: ASUSTEK COMPUTER INC., TAIPEI (TW)

(72) Inventors: Shih-Ming WANG, TAIPEI (TW); Che-Wei CHANG, TAIPEI (TW); Shi-Kai LU, TAIPEI (TW)

(21) Appl. No.: 19/286,783

(22) Filed: Jul. 31, 2025

(30) Foreign Application Priority Data
Jan. 17, 2025 (TW) 114102068

(51) Int. Cl. H02J 1/08; H02J 7/00; H02J 7/34

(52) U.S. Cl. CPC H02J 1/084; H02J 7/345; H02J 7/933; H02J 2207/50

(57) ABSTRACT

A power supply system provided is applied to a portable electronic device adapted to electrically connected to an adapter. The power supply system includes a power input end, a power supply end, a first switch assembly, a battery, a second switch assembly, a super capacitor, and a control unit. The power input end is adapted to electrically connected to the adapter and is electrically connected to the power input end. The battery is electrically connected to the power supply end through the first switch assembly. The super capacitor is electrically connected to the power supply end through the second switch assembly. The control unit is adapted to have the first switch assembly to be in an off state and have the second switch assembly to be in an on state when a system load of the computer system is higher than a maximum power supply wattage of the adapter.

### CROSS-REFERENCE TO RELATED APPLICATION

This application claims the priority benefit of Taiwan application serial No. 114102068, filed on Jan. 17, 2025. The entirety of the above-mentioned patent application is hereby incorporated by reference herein and made a part of the specification.

### BACKGROUND OF THE INVENTION

### Field of the Invention

The disclosure relates to power supply technologies for an electronic device, and in particular, to a power supply system for a portable electronic device.

### Description of the Related Art

A lithium-ion battery is usually used in a portable electronic device as a power source thereof. However, due to a chemical property of the lithium-ion battery, a battery capacity gradually decreases as the battery is used. Generally, a life cycle of the lithium-ion battery is approximately between 300 cycles and 500 cycles, and frequent charging and discharging behaviors significantly shorten a life of the lithium-ion battery. Therefore, how to avoid unnecessary charging and discharging behaviors to prolong a battery life is an urgent problem to be resolved in the art.

### BRIEF SUMMARY OF THE INVENTION

The disclosure provides a power supply system, applicable to a portable electronic device. The portable electronic device includes a computer system and the portable electronic device is adapted to be electrically connected to an adapter to obtain output power of the adapter. The power supply system includes a power input end, a power supply end, a first switch assembly, a battery, a second switch assembly, a super capacitor, and a control unit. The power input end is electrically connected to the adapter to obtain the output power. The power supply end is adapted to be electrically connected to the power input end to supply power to the computer system. The battery is electrically connected to the power supply end through the first switch assembly. The super capacitor is electrically connected to the power supply end through the second switch assembly. The control unit is adapted to have the first switch assembly to be in an off state and have the second switch assembly to be in an on state when a system load of the computer system is higher than a maximum power supply wattage of the adapter.

According to the power supply system provided in the disclosure, when the system load of the computer system is higher than the maximum power supply wattage of the adapter, the super capacitor supplies power to temporarily supplement an insufficient wattage of the adapter. In this way, in addition to preventing the system effectiveness from being limited by a system protection mechanism triggered by instantaneous large current discharging of the battery, because the super capacitor can bear a large quantity of charging and discharging cycles, by combining the super capacitor and the battery, advantages of rapid charging and discharging and high power output of the super capacitor can be effectively utilized to improve system performance. In addition, a combination of the super capacitor and the battery helps prolong a life of the battery and reduce battery replacement frequency and costs of the battery.

### BRIEF DESCRIPTION OF THE DRAWINGS

FIG. 1 is a schematic block diagram of a power supply system according to an embodiment of the disclosure;

FIG. 2 is a schematic block diagram of a power supply system according to another embodiment of the disclosure; and

FIG. 3 is a schematic block diagram of a power supply system according to still another embodiment of the disclosure.

### DETAILED DESCRIPTION OF THE EMBODIMENTS

More detailed descriptions of specific embodiments of the disclosure are provided below with reference to the schematic diagrams. The features and advantages of the disclosure are described more clearly according to the following descriptions and claims. It should be noted that all of the drawings use very simplified forms and imprecise proportions, only being used for assisting in conveniently and clearly explaining the objective of the embodiments of the disclosure.

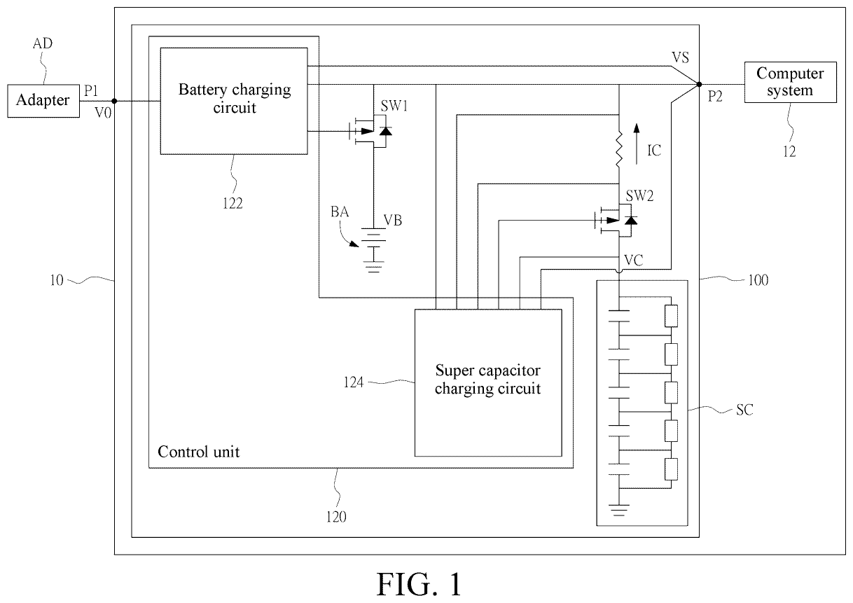

FIG. 1 is a schematic block diagram of a power supply system 100 according to an embodiment of the disclosure. The power supply system 100 is applicable to a portable electronic device 10 inside which a battery BA is arranged for supplying power. The portable electronic device 10 includes a computer system 12, and the portable electronic device is adapted to be electrically connected to an adapter AD to obtain output power V0 of the adapter AD.

As shown in the figure, the power supply system 100 includes a power input end P1, a power supply end P2, a first switch assembly SW1, a battery BA, a second switch assembly SW2, a super capacitor SC, and a control unit 120.

The power input end P1 is adapted to be electrically connected to the adapter AD to obtain the output power V0. The power supply end P2 is electrically connected to the power input end P1, to supply power to the computer system 12.

The battery BA is electrically connected to the power supply end P2 through the first switch assembly SW1, and the battery BA includes a battery voltage VB. In an embodiment, the battery BA is a lithium battery, such as a lithium-ion battery or a lithium polymer battery. In an embodiment, the first switch assembly SW1 is metal-oxide-semiconductor field-effect transistor.

The super capacitor SC is an electrochemical capacitor. The super capacitor SC stores energy through polarization of an electrolyte, and the super capacitor SC mainly stores electrical energy by generating an electrical double layer on a surface of an electrode and by oxidizing and reducing charges. During an energy storage process, no chemical reaction occurs, the super capacitor SC can be repeatedly charged and discharged for hundreds of thousands of times with a feature of rapid charging and discharging and with a relatively long life.

The super capacitor SC is electrically connected to the power supply end P2 through the second switch assembly SW2, and the super capacitor SC includes a capacitor voltage VC. The capacitor voltage VC of the super capacitor SC is approximately the same as the battery voltage VB of the battery BA. In an embodiment, the second switch assembly SW2 is a metal-oxide-semiconductor field-effect transistor.

The control unit 120 includes a battery charging circuit 122 and a super capacitor charging circuit 124. The battery charging circuit 122 is adapted to detect a system voltage VS of the computer system 12 through the power supply end P2, and control, according to the system voltage VS, the first switch assembly SW1 to be in an on state. The super capacitor charging circuit 124 is adapted to detect the system voltage VS of the computer system 12 through the power supply end P2, and control, according to the system voltage VS, the second switch assembly SW2 to be in an on state.

In a case that the adapter AD supplies power to the computer system 12 of the portable electronic device 10, if a system load (mainly from a central processing unit) of the computer system 12 suddenly increases to be higher than a maximum power supply wattage of the adapter AD, the battery charging circuit 122 and the super capacitor charging circuit 124 detect, at the power supply end P2, that the system voltage VS decreases. In this case, the battery charging circuit 122 has the first switch assembly SW1 to be in an off state, and the super capacitor charging circuit 124 has the second switch assembly SW2 to be in an on state.

Specifically, when the adapter AD supplies power to the computer system 12 of the portable electronic device 10, and the battery BA and the super capacitor SC are both in a fully-charged state, the first switch assembly SW1 and the second switch assembly SW2 are both in an off state. In this case, if the system load of the computer system 12 suddenly increases to be higher than the maximum power supply wattage of the adapter AD, the super capacitor charging circuit 124 detects, at the power supply end P2, that the system voltage VS decreases, and the super capacitor charging circuit controls the second switch assembly SW2 to switch from the off state to the on state. In contrast, the first switch assembly SW1 is maintained at the off state.

In this way, when the system load of the computer system 12 suddenly increases to be higher than the maximum power supply wattage of the adapter AD, the super capacitor SC replaces the battery BA for instantaneous power supply to supplement an insufficient wattage. In addition, because the super capacitor SC can bear a larger quantity of charging and discharging cycles compared with a lithium-ion battery, the disclosure helps to reduce a quantity of charging and discharging times of the battery BA, which is conducive to prolonging the life of the battery BA.

It should be noted that limited by a size of the super capacitor SC and power that can be supplied by the super capacitor SC, the super capacitor SC in this embodiment replaces the battery BA to supply power for a short time when the system load suddenly increases to be higher than the maximum power supply wattage of the adapter AD. When the system load is continuously in a heavy-load state, the battery BA needs to be used for supplying power to maintain operating stability of the system.

In an embodiment, the super capacitor charging circuit 124 detects the capacitor voltage VC of the super capacitor SC and a capacitor discharging current IC of the super capacitor SC, to obtain a capacitor electricity amount value. When detecting that the capacitor electricity amount value decreases to be less than a default value due to discharging, the super capacitor charging circuit 124 turns off the second switch assembly SW2, and notifies the battery charging circuit 122 to turn on the first switch assembly SW1, for the battery BA to supply power.

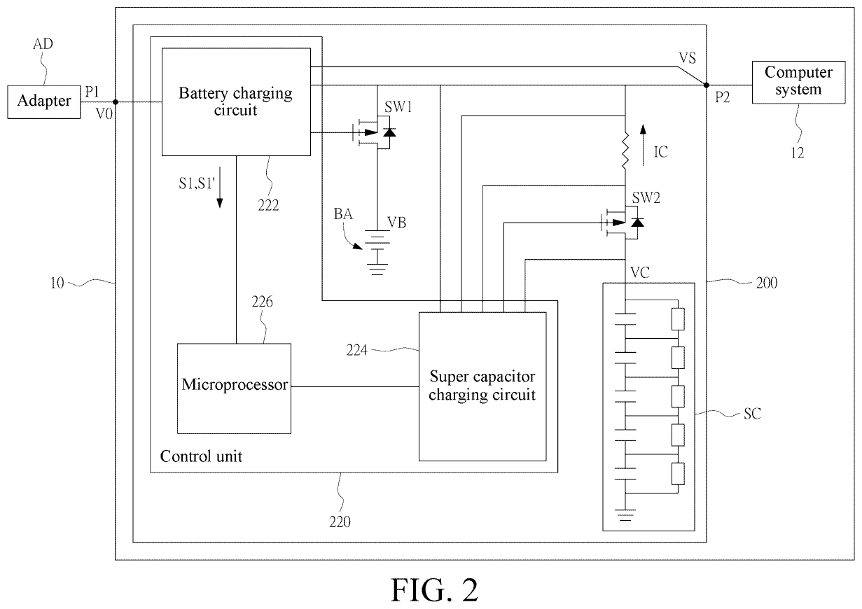

Referring to FIG. 2, FIG. 2 is a schematic block diagram of a power supply system 200 according to another embodiment of the disclosure.

A main difference between the power supply system 200 in this embodiment and the power supply system 100 in the embodiment of FIG. 1 is that an architecture of the control unit 120 and an architecture of a control unit 220 are different.

As shown in the figure, the control unit 220 in this embodiment includes a battery charging circuit 222, a super capacitor charging circuit 224, and a microprocessor 226.

The battery charging circuit 222 is adapted to detect the system voltage VS of the computer system 12 through the power supply end P2 to generate a detection signal S1, and the battery charging circuit is adapted to control the first switch assembly SW1 to be in an on state. The super capacitor charging circuit 224 is adapted to control the second switch assembly SW2 to be in an on state.

The microprocessor 226 is electrically connected to the battery charging circuit 222 and the super capacitor charging circuit 224. In an embodiment, the microprocessor 226 is an embedded controller (EC), and the microprocessor is electrically connected to the battery charging circuit 222 and the super capacitor charging circuit 224 through a system management bus (SMBUS).

The microprocessor 226 is adapted to receive the detection signal S1 from the battery charging circuit 222, and notify, according to the detection signal S1, the battery charging circuit 222 and the super capacitor charging circuit 224 to control the first switch assembly SW1 and the second switch assembly SW2 to be in the on state.

In a case that the adapter AD supplies power to the computer system 12 of the portable electronic device 10, if the system load (mainly from the central processing unit) of the computer system 12 suddenly increases to be higher than the maximum power supply wattage of the adapter AD, the battery charging circuit 222 detects, at the power supply end P2, that the system voltage VS decreases.

In this case, the battery charging circuit 222 generates an overload signal S1′ and transmits the overload signal to the microprocessor 226. The microprocessor 226 notifies, according to the overload signal S1′, the battery charging circuit 222 to have the first switch assembly SW1 to be in an off state, and the microprocessor notifies the super capacitor charging circuit 224 to have the second switch assembly SW2 to be in the on state.

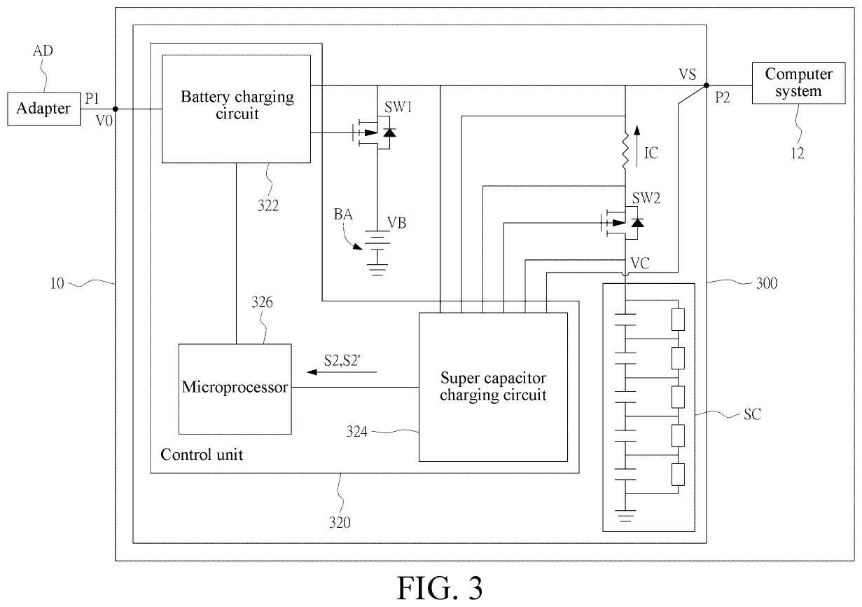

Referring to FIG. 3, FIG. 3 is a schematic block diagram of a power supply system 300 according to still another embodiment of the disclosure.

A main difference between the power supply system 300 in this embodiment and the power supply system 100 in the embodiment of FIG. 1 is that an architecture of the control unit 120 and an architecture of a control unit 320 are different.

As shown in the figure, the control unit 320 in this embodiment includes a battery charging circuit 322, a super capacitor charging circuit 324, and a microprocessor 326.

The battery charging circuit 322 is adapted to control the first switch assembly SW1 to be in an on state. The super capacitor charging circuit 324 is adapted to detect the system voltage VS of the computer system 12 through the power supply end P2 to generate a detection signal S2, and the super capacitor charging circuit is adapted to control the second switch assembly SW2 to be in an on state.

The microprocessor 326 is electrically connected to the battery charging circuit 322 and the super capacitor charging circuit 324. In an embodiment, the microprocessor 326 is an embedded controller (EC), and the microprocessor is electrically connected to the battery charging circuit 322 and the super capacitor charging circuit 324 through a system management bus (SMBUS).

The microprocessor 326 is adapted to receive the detection signal S2 from the super capacitor charging circuit 324, and notify, according to the detection signal S2, the battery charging circuit 322 and the super capacitor charging circuit 324 to control the first switch assembly SW1 and the second switch assembly SW2 to be in the on state.

In a case that the adapter AD supplies power to the computer system 12 of the portable electronic device 10, if the system load (mainly from the central processing unit) of the computer system 12 suddenly increases to be higher than the maximum power supply wattage of the adapter AD, the super capacitor charging circuit 324 detects, at the power supply end P2, that the system voltage VS decreases.

In this case, the super capacitor charging circuit 324 generates an overload signal S2′ and transmits the overload signal S2′ to the microprocessor 326. The microprocessor 326 notifies, according to the overload signal S2′, the battery charging circuit 322 to have the first switch assembly SW1 to be in an off state, and the microprocessor notifies the super capacitor charging circuit 324 to have the second switch assembly SW2 to be in the on state.

In conclusion, according to the power supply systems 100, 200, and 300 provided in the disclosure, when the system load of the computer system 12 is higher than the maximum power supply wattage of the adapter AD, the super capacitor SC supplies power to temporarily supplement an insufficient wattage of the adapter AD. In this way, in addition to preventing the system effectiveness from being limited by a system protection mechanism triggered by instantaneous large current discharging of the battery BA, because the super capacitor SC can bear a large quantity of charging and discharging cycles, by combining the super capacitor SC and the battery BA, advantages of rapid charging and discharging and high power output of the superconductor SC can be effectively utilized to improve system performance. In addition, a combination of the super capacitor SC and the battery BA helps prolong a life of the battery BA and reduce replacement frequency and costs of the battery BA.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A power supply system, applicable to a portable electronic device, wherein the portable electronic device comprises a computer system, the portable electronic device is adapted to be electrically connected to an adapter to obtain output power of the adapter, and the power supply system comprises:
a power input end, adapted to be electrically connected to the adapter to obtain the output power;
a power supply end, electrically connected to the power input end, to supply power to the computer system;
a first switch assembly;
a battery, electrically connected to the power supply end through the first switch assembly;
a second switch assembly;
a super capacitor, electrically connected to the power supply end through the second switch assembly; and
a control unit, adapted to have the first switch assembly to be in an off state and have the second switch assembly to be in an on state when a system load of the computer system is higher than a maximum power supply wattage of the adapter.

2. The power supply system according to claim 1, wherein the battery comprises a battery voltage, and the super capacitor comprises a capacitor voltage, wherein the battery voltage is approximately the same as the capacitor voltage.

3. The power supply system according to claim 1, wherein the first switch assembly is a metal-oxide-semiconductor field-effect transistor.

4. The power supply system according to claim 1, wherein the second switch assembly is a metal-oxide-semiconductor field-effect transistor.

5. The power supply system according to claim 1, wherein the control unit comprises a battery charging circuit, adapted to detect a system voltage of the computer system through the power supply end and control the first switch assembly according to the system voltage.

6. The power supply system according to claim 1, wherein the control unit comprises a super capacitor charging circuit, adapted to detect a system voltage of the computer system through the power supply end and control the second switch assembly according to the system voltage.

7. The power supply system according to claim 1, wherein the control unit comprises a battery charging circuit, a super capacitor charging circuit, and a microprocessor, wherein the battery charging circuit is adapted to detect a system voltage of the computer system through the power supply end, and when the system voltage decreases, generate an overload signal and transmit the overload signal to the microprocessor, the microprocessor notifies the battery charging circuit according to the overload signal to have the first switch assembly to be in the off state, and the microprocessor notifies the super capacitor charging circuit to have the second switch assembly to be in the on state.

8. The power supply system according to claim 1, wherein the control unit comprises a battery charging circuit, a super capacitor charging circuit, and a microprocessor, wherein the super capacitor charging circuit is adapted to detect a system voltage of the computer system through the power supply end, and when the system voltage decreases, generate an overload signal and transmit the overload signal to the microprocessor, the microprocessor notifies the battery charging circuit according to the overload signal to have the first switch assembly to be in the off state, and the microprocessor notifies the super capacitor charging circuit to have the second switch assembly to be in the on state.

9. The power supply system according to claim 8, wherein the super capacitor charging circuit is adapted to detect a capacitor voltage of the super capacitor and a capacitor discharging current of the super capacitor, to obtain a capacitor electricity amount value, and when the capacitor electricity amount value is less than a default value, have the second switch assembly in an off state.
